(19) United States
(12) Patent Application Publication
(10) Pub. No.: US 2004/0012664 A1
(43) Pub. Date: Jan. 22, 2004

(54) Apparatus for cutting fixing-medium, and liquid fixing apparatus

(75) Inventor: Satoshi Fujioka, Nagano (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/392,330

(22) Filed: Mar. 20, 2003

(30) Foreign Application Priority Data
Mar. 20, 2002 (JP) P2002-77647
Feb. 27, 2003 (JP) P2003-050828

(51) Int. Cl. B41J 2/385

(52) U.S. Cl. 347/157

(57) ABSTRACT

A cutting apparatus has press rollers which rotationally move while pressing a fixing-medium in a transverse direction, and a cutter blade which is moved along with the press rollers and pressingly cuts the fixing-medium in the transverse direction. As a result, the press rollers rotate over a recording surface at the time of cutting of the fixing-medium, thereby avoiding occurrence of unwanted friction. Exfoliation of ink from a wet recording surface and damage on a recorded image can be prevented.

The preset application is based on Japanese Patent Applications Nos. 2002-77647 and 2003-50828, the entire contents of which are incorporated herein by reference.

### BACKGROUND OF THE INVENTION

1. Field of the Invention

The invention relates to a cutting apparatus for cutting a fixing-medium and to a recording apparatus or liquid fixing apparatus such equipped with the cutting apparatus.

2. Related Art

Among printers, a large inkjet printer can effect recording on a fixing-medium of comparatively large size; e.g., JIS (Japanese Industrial Standards) A-1 rolled paper or JIS B-1 rolled paper. In the case of such a large inkjet printer, the rolled paper is supplied from a feeding unit to a recording unit, where the paper is subjected to recording. The rolled paper is then discharged outside from a discharging unit. The rolled paper that has been output to a predetermined length is cut by a cutting section provided at the discharging unit (see JP-A-2000-158738).

The above-descried related-art cutting section is constructed such that a paper pressing section, which is disposed around a cutter blade and has a flat pressing surface, presses the rolled paper and such that the cutter is moved along the rolled paper together with the paper pressing section and cuts the paper pressingly. When the rolled paper that has been subjected to so-called frameless printing is cut, the flat pressing surface of the paper pressing section rubs against a recording surface. Eventually, wet ink on the recording surface is scraped so that the recording surface, particularly an upper recorded image, is sometimes damaged.

### SUMMARY OF THE INVENTION

The invention has been conceived in view of those problems and is aimed at providing a cutting apparatus capable of cutting a fixing-medium without damaging, as well as a liquid fixing apparatus equipped with the cutting apparatus.

To achieve the object, the invention provides a cutting apparatus for cutting a fixing-medium, comprising a press roller which rotationally moves while pressing the fixing-medium in a transverse direction; and a cutter blade which moves in conjunction with the press roller and pressingly cuts the fixing-medium in a transverse direction. As a result, the press rollers rolls over a recording surface at the time of cutting of the fixing-medium, thereby avoiding occurrence of unwanted friction. Exfoliation of ink from a wet recording surface and damage on a recorded image can be prevented.

Further, the press roller is preferably provided on either side of the cutter blade. As a result, a portion of the fixing-medium with which the cutter blade is to come into contact at the time of cutting of the fixing-medium can be pressed flat by means of the roller, thereby enabling highly-accurate cutting operation.

Preferably, the press roller is formed from PFA resin. Moreover, a surface of the press roller which comes into contact with the fixing-medium is preferably subjected to water repellent treatment. As a result, the press rollers roll over the wet recording surface when the entire surface of the fixing-medium is subjected to recording. Even in such a case, by virtue of the water repellent effect, the fixing-medium does not adhere to the press rollers, thus preventing occurrence of defects in the recorded image.

The cutting apparatus preferably further comprises an actuating device for bringing the press roller and the cutter blade into contact with or out of contact with the fixing-medium. AS a result, the press rollers and the cutter blade can be pressed against the fixing-medium without failure at the time of cutting of the fixing-medium. Hence, cutting operation can be performed with high accuracy. At the time of discharge of the fixing-medium, the press rollers and the cutting blade can be spaced far apart from the fixing-medium. Hence, occurrence of interference between the press rollers, the cutter blade, and the fixing-medium can be prevented.

A liquid fixing apparatus for recording information on a fixing-medium is preferably equipped with the cutting apparatus. Consequently, a liquid fixing apparatus which performs the foregoing operations can be provided.

In such the case, the cutting apparatus may be fixed to a carriage on which a recording head is mounted.

Here, the recording head includes a liquid jetting head such as ink jet printing head or other types of recording head such as dot impact printing head.

### BRIEF DESCRIPTION OF THE DRAWINGS

FIG. 1 is a perspective view showing an example configuration of an inkjet printer which is an example of liquid fixing apparatus according to an embodiment of the invention;

FIG. 2 is a perspective view showing an example internal construction of the principal section of the printer shown in FIG. 1;

FIG. 3 is a first view showing procedures for using the printer shown in FIG. 1;

FIG. 4 is a second view showing the procedures for using the printer shown in FIG. 1;

FIG. 5 is a third view showing the procedures for using the printer shown in FIG. 1;

FIG. 6 is a fourth view showing the procedures for using the printer shown in FIG. 1;

FIG. 7 is a fifth view showing the procedures for using the printer shown in FIG. 1;

FIG. 8 is a sixth view showing the procedures for using the printer shown in FIG. 1;

FIG. 9 is a seventh view showing the procedures for using the printer shown in FIG. 1;

FIG. 10 is an eighth view showing the procedures for using the printer shown in FIG. 1;

FIG. 11 is a ninth view showing the procedures for using the printer shown in FIG. 1;

FIG. 12 is a perspective view showing details of an ink cartridge holder of the printer shown in FIG. 1;

FIG. 13 is a perspective view of the ink cartridge to be loaded into the ink cartridge holder shown in FIG. 12 when viewed from the back;

FIG. 14 is a perspective view showing the internal structure of a housing for housing an ink cartridge of a single color in the holder body of the ink cartridge holder shown in FIG. 12;

FIGS. 15A and 15B are plan views showing details of an ink supply needle of the housing of the ink cartridge shown in FIG. 14;

FIG. 16 is a schematic cross-sectional side view showing a rolled paper transport surface including a paper transport guide section of the printer shown in FIG. 1;

FIG. 17 is a plan view showing surroundings of the paper transport guide section shown in FIG. 16; and

FIGS. 18A and 18B are side views showing surroundings of a cutting apparatus of the printer shown in FIG. 1.

### DETAILED DESCRIPTION OF THE PREFERRED EMBODIMENTS

An embodiment of the invention will be described in detail hereinbelow by reference to the drawings.

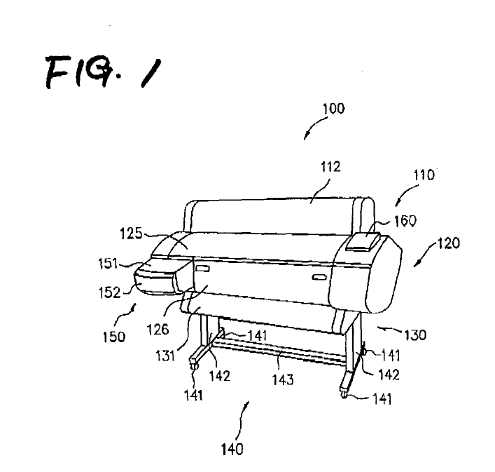

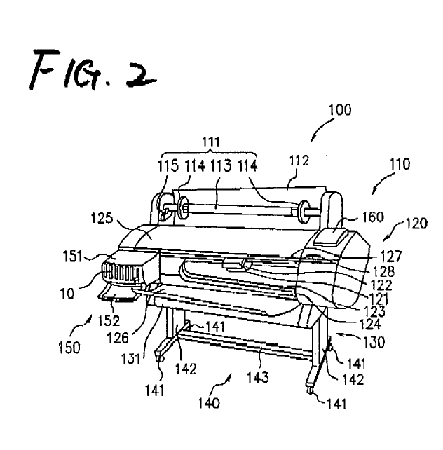

FIG. 1 is a perspective view showing an example configuration of an inkjet printer which is an example of liquid fixing apparatus according to an embodiment of the invention. FIG. 2 is a perspective view showing an example internal configuration of the principal section of the inkjet printer. As shown in FIGS. 1 and 2, an inkjet printer 100 is a large-sized printer capable of effecting recording on recording paper of comparatively large size; e.g., JIS (Japanese Industrial Standards) A1-size or JIS B1-size. A feeding unit 110, a recording unit 120, a discharging unit 130, and a leg section 140 are arranged in this order from the top. The recording unit 120 and the discharging unit 130 are integrated together as a main unit. The feeding unit 110 and the leg section 140 are separable from the main unit.

As shown in FIG. 1, the feeding unit 110 is provided so as to project in an upper and rearward direction with respect to the main units 120, 130. As shown in FIG. 2, a rolled paper holder 111 which enables loading of a single piece of rolled recording paper (hereinafter simply called “rolled papers”) is provided in the paper feeding section 110. As shown in FIGS. 1 and 2, a flip-up and reclosable rolled paper cover 112 is attached to the front side of the paper feeding section 110 so as to cover the rolled paper holder 111.

As shown in FIG. 2, the rolled paper holder 111 comprises a spindle 113 and a pair of flanged rolled paper pressers 114, which hold rolled paper; and a pair of spindle receivers 115 which are provided along both internal wall surfaces of the paper feeding section 110 and enable detachment/attachment and suspension of the spindle 113. Rolled paper is fitted around the center of the spindle 113, and both ends of the spindle 113 are caught and rotatably supported by the spindle receivers 115 with the rolled paper being sandwiched between the rolled paper pressers 114. As shown in FIGS. 1 and 2, the entire rolled paper cover 112 is supported in a pivotable manner and opened/closed by the user raising or lowering a lower portion of the rolled paper cover 112.

As shown in FIG. 2, the recording unit 120 has a carriage 122 equipped with a plurality of recording heads 121; a flexible flat cable (hereinafter abbreviated “FFC”) 123 for electrically connecting the recording heads 121 and an unillustrated control section for effecting recording operation; a plurality of ink tubes 124 which connect the respective recording heads 121 to ink-filled ink cartridges 10; unillustrated paper feed rollers for transporting the rolled paper in a secondary scanning direction; and unillustrated paper suction means or the like for preventing occurrence of lifting of the rolled paper. As shown in FIGS. 1 and 2, a top cover 125 and a front cover 126 are attached to an upper surface and a front surface, respectively, of the recording unit 120 so as to cover the recording heads 121 and the carriage 122.

The recording heads 121 include a black ink recording head 121 for ejecting black ink, and a plurality of color ink recording heads 121 for ejecting other colors of ink, such as light-yellow, yellow, light-cyan, cyan, light-magenta, magenta, and others. Each of the recording heads 121 has a pressure generation chamber and nozzle orifices connected thereto. Ink is stored in the pressure generation chamber and pressurized at a predetermined pressure, whereby ink droplets of controlled size are ejected toward the rolled paper from the nozzle orifices.

As shown in FIG. 2, the carriage 122 is suspended on a rail 127 provided in a main scanning direction byway of a roller and is connected to a carriage belt 128. When the carriage belt 128 is driven by an unillustrated carriage drive device, the carriage 122 moves back and forth while being guided by the rail 127 in conjunction with movement of the carriage belt 128.

One end of the FFC 123 is connected to a connector of the control section, and the other end of the same is connected to a connector of the recording heads 121. The FFC 123 sends a recording signal from the control section to the recording heads 121. Ink tubes for various colors of ink are provided. The ink tubes 124 are at one end thereof connected to ink cartridges 10 of corresponding colors by way of ink pressurization supply means and are at the other end thereof connected to the recording heads 121 of corresponding colors. The ink tubes 124 send the colors of ink pressurized by the ink pressurization supply means to the recording heads 121 from the ink cartridges 10.

As shown in FIGS. 1 and 2, a lower portion of the front cover 126 is pivotally supported, and the user raises/lowers an upper portion of the same, thereby reclosably opening the front cover 126. The user can widely release the recording unit 120 by opening the front cover 126, thereby facilitating maintenance of the recording heads 121, the carriage 122, and other elements.

As shown in FIGS. 1 and 2, the discharging unit 130 has a paper output guide 131 constituting a portion of a path along which the rolled paper is transported in the secondary scanning direction; and an unillustrated paper output roller for transporting the rolled paper in the secondary scanning direction. The paper output guide 131 is formed as a flat tapered surface which projects toward the front side, thereby smoothly guiding downward the rolled paper transported from above.

As shown in FIGS. 1 and 2, the leg section 140 has two support poles 142, each having movement rollers 141, and a reinforcement rod 143 extending between the support poles 142. The paper feeding section 110 and the main units 120, 130 are mounted on the top of the support poles 142 and secured with screws. Since the movement rollers 141 are attached to the support poles 142, the paper feeding section 110 and the main units 120, 130, which are heavy in weight, can be smoothly moved to a desired location and set in place. An output paper receiver can be placed between the support legs 142 of the leg section 140 for receiving the rolled paper output from the discharging unit 130.

Further, as shown in FIGS. 1 and 2, an ink cartridge holder 150 is disposed on the left side of the main units 120, 130 when viewed from the front, wherein the ink cartridge holder 150 has a holder body 151 for housing and holding the color ink cartridges 10, and a cover 152 for covering the front of the holder body 151. In the ink cartridge holder 150, a lower portion of the cover 152 is pivotally supported on the holder body 151. The user raises or lowers an upper portion of the cover 152 in a pressing manner, thereby opening/closing the cover 152.

As shown in FIGS. 1 and 2, an operation panel 160—by way of which the user performs a recording control operation or the like—is provided at an upper right position on the main units 120, 130 when viewed from the front. A liquid-crystal screen and various buttons are provided on the operation panel 160, and the user can operate the buttons while viewing and checking the liquid-crystal screen.

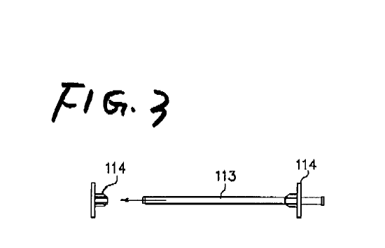

When the inkjet printer 100 having such a construction is used, the spindle 113 constituting the rolled paper holder 111 is taken out of the paper feeding section 110. As shown in FIG. 3, one rolled paper presser 114 inserted into the spindle 113 is pulled off from one end thereof.

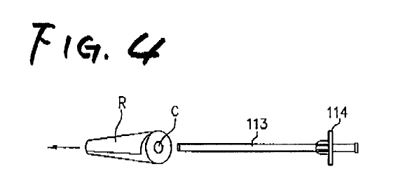

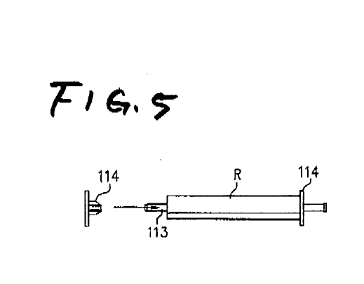

As shown in FIG. 4, one end of the spindle 113 is inserted into one end of a shaft hole C of rolled paper R in a penetrating manner. As shown in FIG. 5, one end of the shaft hole C of the rolled paper R is fitted around and brought into contact with the other rolled paper presser 114 remaining fixedly secured at the other end of the spindle 113. Subsequently, the rolled paper 114 is slid onto one end of the spindle 113 and fitted to the other end of the shaft hole C of the rolled paper R. As a result, the rolled paper R can rotate in conjunction with the spindle 113.

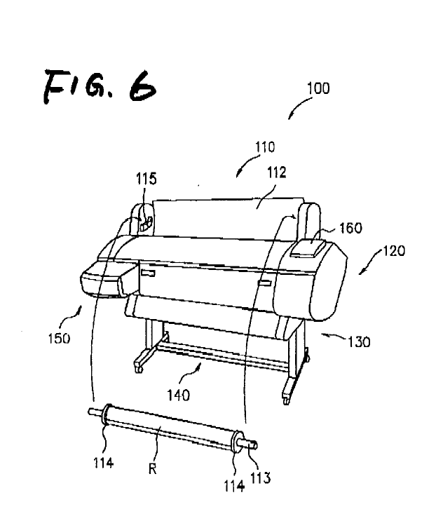

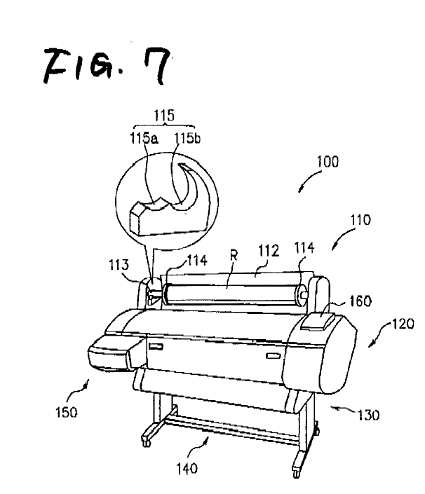

As shown in FIG. 6, both ends of the spindle 113 having the rolled paper R attached thereto are raised to the paper feeding section 110. As shown in FIG. 7, the spindle receiver 115 has a comparatively shallow recess 15a for temporarily receiving the end of the spindle 113, and a comparatively deep recess 115b for rotatably supporting the end of the spindle 113. The recesses 115a and 115b are provided side by side along the front and rear direction. The recess 115a provided at a position close to the viewer is provided so as to temporarily receive the spindle 113 having the heavy rolled paper R attached thereto, because difficulty is encountered in loading the spindle 113 to the regular recess 115b by a single operation.

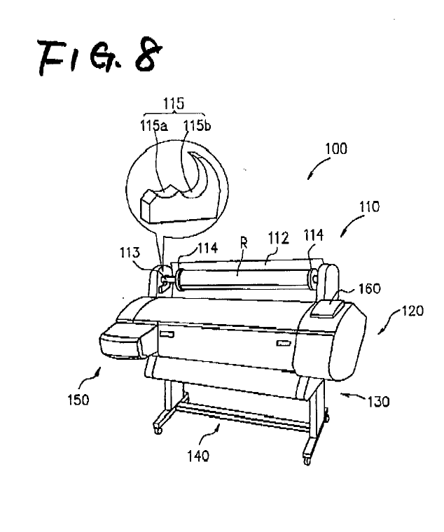

As shown in FIG. 7, both ends of the spindle 113 having the rolled paper R attached thereto are temporarily held in the temporary-receiver recesses 115a of the spindle receiver 115. As shown in FIG. 8, one end of the spindle 113 having the rolled paper R attached thereto is brought to rest on the regular recess 115b of the spindle receiver 115. Next, the other end of the spindle 113 having the rolled paper R attached thereto is brought to rest on the corresponding regular recess 115b of the spindle receiver 115. As a result, the spindle 113 having the rolled paper R attached thereto can be readily and safely set in the paper feeding section 110.

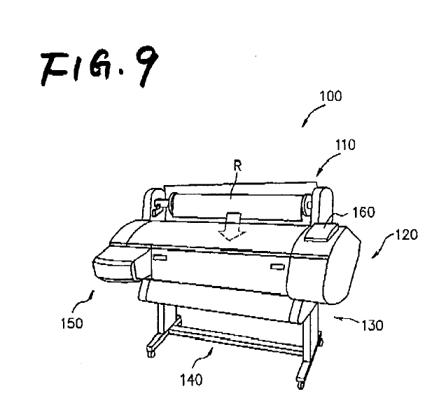

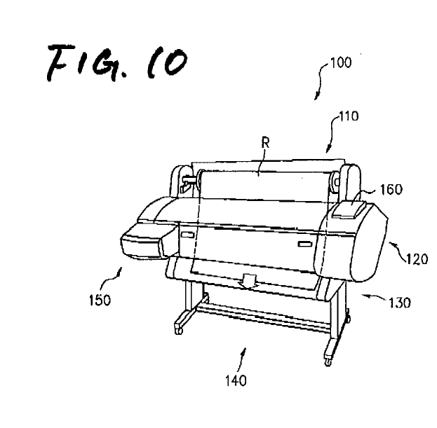

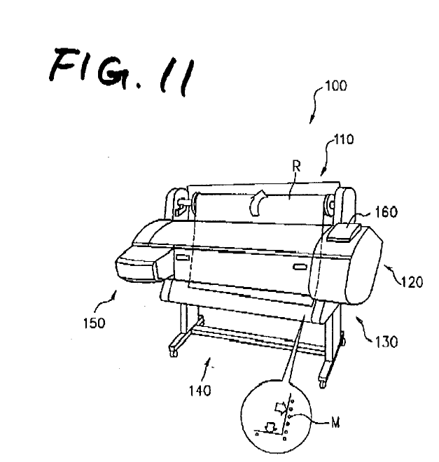

Next, as shown in FIG. 9, the leading edge of the rolled paper R is drawn downward and pulled up to the transport path of the discharging unit 130 while passing by the transport path of the recording unit 120 in the manner shown in FIG. 10. As shown in FIG. 11, the rolled paper R is spun in a take-up direction, thereby positioning the leading edge of the rolled paper R to a marker M provided in, e.g., the paper output guide 131. Subsequently, the inkjet printer 100 is activated, and the recording heads 121 are caused to eject ink droplets while being moved in the main scanning direction simultaneously with the rolled paper R being fed in the secondary scanning direction, thereby recording predetermined information on the rolled paper R and outputting the rolled paper.

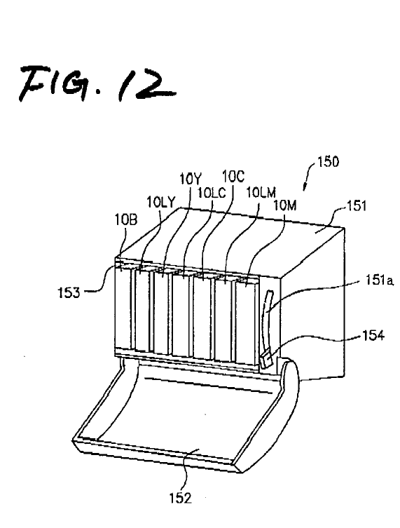

FIG. 12 is a perspective view showing details of the ink cartridge holder 150. The ink cartridge 150 has the holder body 151 attached to the left side on the front of the main unit 120 of the inkjet printer 100, and the cover 152 attached to the front side of the holder body 151. A housing 153 for housing the ink cartridges 10 and a control lever 154 which can be moved vertically are provided side by side within the holder body 151. The lower portion of the cover 152 is rotatably supported on the lower portion of the holder body 151. When the cover 152 is rotated downward, the front of the holder body 151 is opened. When the cover 152 is rotated upward, the front of the holder body 151 is closed.

The housing 153 provided in the holder main Unit 151 is partitioned so that a total of seven color ink cartridges can be independently withdrawn and pushed in; for example, in this sequence from the left in the drawing, a black ink cartridge 10B, a light-yellow ink cartridge 10LY, a yellow ink cartridge 10Y, a light-cyan ink cartridge 10LC, a cyan ink cartridge 10C, a light-magenta ink cartridge 10LM, and a magenta ink cartridge 10M.

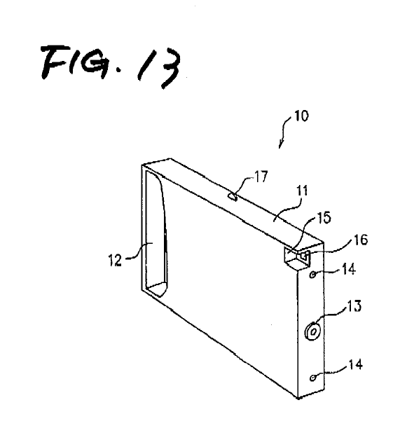

FIG. 13 is a perspective view showing one of the ink cartridges 10 when viewed from the back. Here, the ink cartridge 10 comprises a casing 11 formed from, e.g., hard plastic material, into a rectangular parallelepiped. An ink tank—which is formed from, e.g., a flexible material, into the shape of a bag and filled with ink—is sealed in the casing 11. A recessed grip section 12 is formed in a position on one side surface of the casing 11 and close to the front side of the same so that the user can rest a finger on the grip section 12 when withdrawing or the ink cartridge 10 from or pressing the same into the housing 153.

Only, e.g., six color ink cartridges are housed in a holder body of a related-art ink cartridge holder, and comparatively sufficient space remains. Therefore, the user can put his/her hands into the holder body 151 when withdrawing or pressing in the ink cartridges into a housing. However, in the embodiment, the housing 153 for housing the seven color ink cartridges 10 and the control lever 154 must be provided side by side within the holder body 151 of the ink cartridge holder 150 that is identical in size with the conventional ink cartridge holder, thereby eliminating space. For these reasons, the recessed grip section 12 is formed in the ink cartridge 10, thereby facilitating withdrawal of the ink cartridge 10 from and pressing of the same into the storage section 153.

An ink supply port 13 is formed in the center on the rear surface of the casing 11, wherein the port 13 is covered with a rubber packing and connected to the inner ink tank. Positioning holes 14 to be used for positioning the ink cartridge 10 when the ink cartridge 10 is pushed into the housing 153 are formed on both sides of the ink supply port 13. A recess 15 is formed in an upper position on the rear surface of the casing 11, and an IC 16 is labeled to the recess 15. Ink information about the ink cartridge 10; for example, a production number, ink color, and the remaining quantity of ink, are read from or written into the IC 16. A latch engagement 17 to be used when the ink cartridge 10 is housed in the housing 153 is formed in the center on the upper surface of the casing 11.

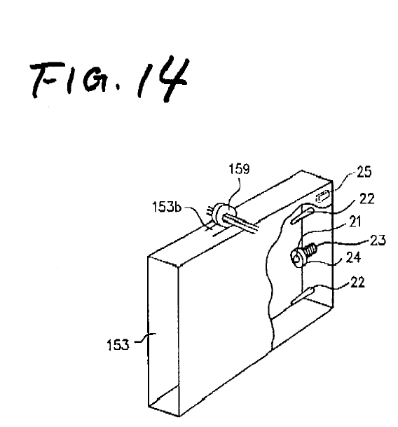

FIG. 14 is a perspective view showing the internal structure of the housing 153 provided in the holder body 151 for the ink cartridge 10 of a single color. An ink supply needle 21 to be inserted into the ink supply port 13 of the ink cartridge 10 and positioning needles 22 to be inserted into the positioning holes 14 of the ink cartridge 10 are provided on the inner rear surface of the housing 153 so as to project toward the direction in which the ink cartridge 10 is to be withdrawn or pushed in.

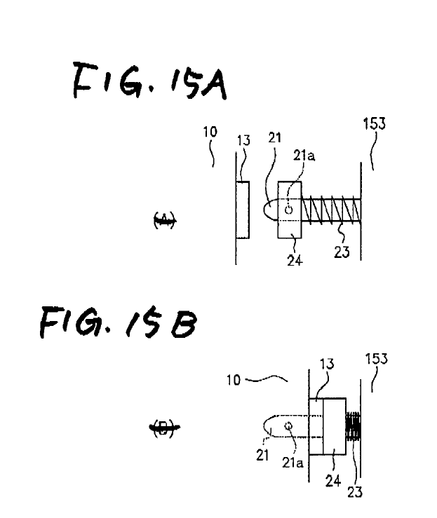

FIG. 15A is a plan view showing details of the ink supply needle 21. A supply port 21a is drilled in the side surface at the leading end of the ink supply needle 21. The rear end of the ink supply needle 21 is connected to the ink tube 124. A cylindrical rubber valve 24 is fitted around the ink supply needle 21. By means of a compression spring 23 provided in the vicinity of the rear end of the ink supply needle 21, the valve 24 is axially forced so as to close the supply port 21a. As a result, the ink supply system provided in the inkjet printer 100 can be maintained in a closed state.

As shown in FIG. 15A, when the user pushes the ink cartridge 10 into the housing 153 having such a construction, the ink supply needle 21 is inserted into the ink supply port 13 in such a manner as shown in FIG. 15B. The valve 24 is pushed toward the rear end of the ink supply needle 21 when pressed by the rubber packing of the ink supply port 13. As a result, the supply port 21a covered with the valve 24 is uncovered, and the ink stored in the ink tank of the ink cartridge 10 is supplied to the ink tube 124 from the ink supply port 13 by way of the supply port 21a of the ink supply needle 21.

When the user pulls the ink cartridge 10 from the housing 153, the ink supply needle 21 is also withdrawn from the ink supply port 13. The valve 24 pressed by the rubber packing of the ink supply port 13 is pushed toward the leading edge of the ink supply needle 21 under restoration force of the compression spring 23. As a result, the exposed supply port 21a is again covered with the valve 24.

As shown in FIG. 14, a connector 25 to be electrically connected to the IC 16 of the ink cartridge 10 is affixed to an upper position on the inner rear surface of the housing 153. The connector 25 is connected to the FFC 123. The control section of the inkjet printer 100 can read and write ink information from and on the IC 16 of the ink cartridge 10. Further, a latch pawl 153b is formed in the center on the upper surface of the housing 153. In association with movement of a cam 159, the latch pawl 153b is engaged with or disengaged from the latch projection 17 of the ink cartridge 10.

As shown in FIG. 12, the control lever 154 provided in the holder body 151 is provided so as to be vertically pivotable along a guide groove 151a formed longitudinally in the holder body 151. The control lever 154 is vertically pivoted, thereby electrically controlling writing of the ink information into the IC 16 provided on the ink cartridge 10 and mechanically controlling insertion and withdrawal of the ink cartridge 10 into and from the housing 153.

When the control lever 154 is positioned at the topmost end, writing of the ink information to the IC 16 provided on the ink cartridge 10 is inhibited, but insertion or withdrawal of the ink cartridge 10 into or from the housing 153 is enabled. In contrast, when the control lever 154 is positioned at the lowermost end, writing of the ink information to the IC 16 provided on the ink cartridge 10 is enabled, but insertion or withdrawal of the ink cartridge 10 to and from the housing 153 is inhibited.

Provision of such a control lever 154 having such a function enables usage of large ink cartridges. Specifically, writing of the ink information into the IC provided on the ink cartridge has hitherto been controlled by reclosable action of the cover of the ink cartridge holder. However, when the large ink cartridge is set in the holder body, the cartridge projects forward, thereby hindering closing of the cover. Therefore, writing of the ink information to the IC provided on the ink cartridge cannot be controlled.

In contrast, writing of the ink information to the IC 16 provided on the ink cartridge 10 of the embodiment is controlled by pivotal movement of the control lever 154 of the ink cartridge holder 150 in the manner set forth. Even when a large ink cartridge projects forward as a result of being set in the holder body 151, to thereby hinder closing of the cover 152, writing of the ink information into an IC provided on the large ink cartridge can be controlled.

As mentioned previously, the ink stored in the color ink cartridges 10 housed in the ink cartridge holder 150 is supplied to the recording heads 121 after having been pressurized by the ink pressurization supply means. Therefore, when the ink supply means utilizes the head as does the conventional inkjet printer, the ink cartridge holder must be disposed at a position higher than the carriage. However, ink can be supplied everywhere the ink cartridge 150 is disposed. Hence, the location of the ink cartridge holder can be set freely.

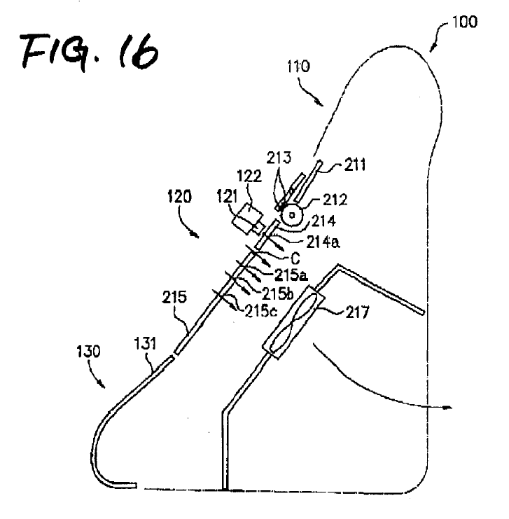

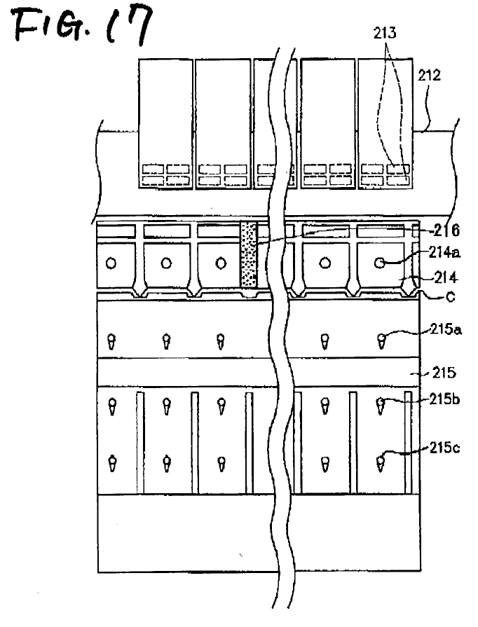

FIG. 16 is a schematic cross-sectional side view showing a transport surface of the rolled paper, including the paper transport guide section of the inkjet printer 100; and FIG. 17 is a plan view showing the surroundings of the paper transport guide section. The paper transport path extending from the paper feeding section 110 to the discharging unit 130 by way of the recording unit 120 is provided so as to be inclined from an upper position on the back of the inkjet printer 100 to a lower position on the front of the same.

The paper transport path comprises a flat paper feed guide 211 provided so as to extend from the paper feeding section 110 to the recording unit 120; a paper feed roller 212 and a follower roller 213 which are provided so as to oppose each other and which can be brought into and out of contact with each other; a platen 214 which serves as a flat paper transport guide section provided so as to oppose the recording heads 121 mounted on the carriage 122; a flat paper suction section 215 provided so as to extend from the recording unit 120 to the discharging unit 130; and a paper output guide 131 provided in the discharging unit 130.

The surface of the paper feeding guide section 211 and that of the paper output guide 131 act as paper transport surfaces. Further, the surface of the paper suction section 215 acts as a paper transport surface and the paper suction surface. As shown in FIG. 17, the paper suction section 215 comprises a plurality of suction ports 215a, 215b, and 215c which are provided side by side in the main scanning direction and in three lines in the secondary scanning direction. As shown in FIG. 16, outside air is drawn by suction from the suction ports 215a, 215b, and 215c by means of a fan 217 provided in the recording unit 120, thereby attracting the rolled paper transported over the paper suction section 215.

The surface of the platen 214 acts as the paper transport guide surface and also as the paper suction surface. Specifically, as shown in FIG. 17, the platen 214 has a plurality of suction ports 214a arranged side by side in the main scanning direction. As shown in FIG. 16, the outside air is drawn by suction from the respective suction ports 214a by means of the fan 217 provided in the recording unit 120, thereby attracting the rolled paper transported over the platen 214. Consequently, even when the rolled paper has a particularly large width, the rolled paper is transversely attracted and made flat by suction over the platen 214 without fail, thereby maintaining high recording accuracy.

As shown in FIG. 17, a clearance C is provided between the platen 214 and the suction section 215, and as shown in FIG. 16 the outside air is drawn by suction from the clearance C by means of the fan 217 provided in the recording unit 120. As a result, the rolled paper transported over the clearance C is attracted. Consequently, the rolled paper is attracted even at a position between the platen 214 and the suction section 215, whereby the rolled paper is made more flat by the platen 214. Higher recording accuracy can be maintained. Even when the suction ports 214a are formed in the platen 214 to draw the rolled paper or when the clearance C is provided between the platen 214 and the suction section 215 to draw the rolled paper, an advantage similar to that mentioned above is yielded.

The platen 214 is divided in accordance with the width of the rolled paper; for example, into seven equal parts, each part measuring four inches, and ink absorbing material 216; e.g., sponge or nonwoven fabric cloth, is provided into each of the sub-divisions. In this way, the platen 214 is divided into sub-divisions, and each of the sub-divisions is provided with the ink absorbing material 216. As a result, at the time of so-called frameless printing by means of which the entire surface of rolled paper is subjected to recording without margins, ink ejected outside the rolled paper of any size can be absorbed and recovered, thereby preventing staining of the recording heads 121 and the rolled paper.

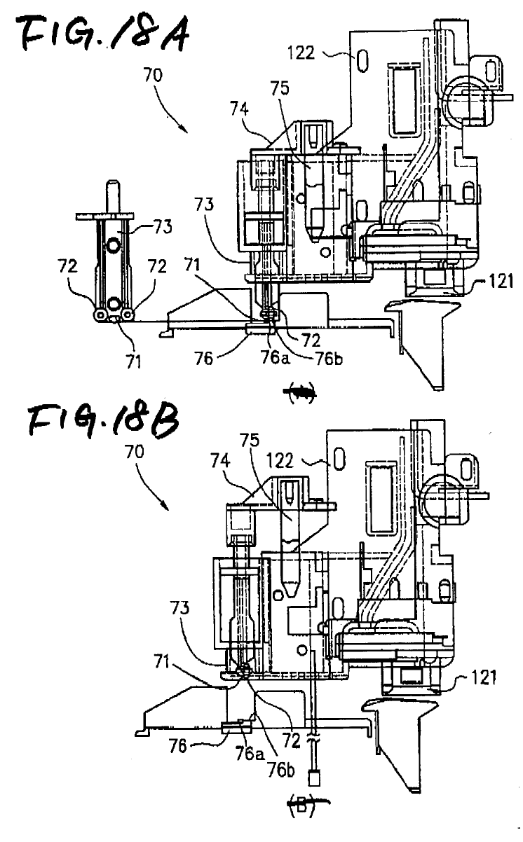

FIG. 18A is a side view showing surroundings of a cutting apparatus 70 for cutting the rolled paper. The cutting apparatus 70 comprises a cutter blade 71; paper press rollers 72 disposed such that the cutter blade 71 is interposed therebetween; a holder 73 which retains at the lower end thereof the cutter blade 71 and the paper press rollers 72; and a plunger 75 which is connected to the holder 73 by way of a joint arm 74 and vertically actuates the holder 73. The cutting apparatus 70 is fixed to oppose the front of the carriage 122.

The cutter blade 71 is an existing cutting blade. The cutter blade 71 is moved in the transverse direction of the rolled paper, thereby cutting the rolled paper pressingly. The cutter blade 71 is engaged in a cutter groove step 76a formed in a position on a sub-platen 76 opposing the cutter blade 71, wherein the sub-platen 76 is disposed so as to oppose the cutting apparatus 70. The cutter blade 71 is moved along the cutter groove step 76a, thereby cutting the rolled paper placed on the sub-platen 76.

The paper press rollers 72 are rotatably mounted and moved along with the cutter blade 71 while pressing the rolled paper in the transverse direction. Specifically, one of the paper press rollers 72 comes into contact with a rear position on the cutter groove step 76a of the sub-platen 76; that is, a roller slide surface 76b formed at a position opposing that paper press roller 72, and moves along with the cutter blade 71.

In this way, the paper press rollers 72 spin over the paper surface at the time of cutting of the rolled paper. Hence, unwanted friction does not arise, thereby preventing exfoliation of ink from a recording surface or damage on a recorded image. The paper press rollers 72 have the function of protecting the recording surface when the rolled paper is cut, Namely, although the paper press rollers 72 are disposed in proximity to or away from the cutter blade 71, the function is not impaired. Therefore, either of these arrangements may be adopted.

Further, the paper press rollers 72 are formed from, e.g., PFA resin having a high water repellent characteristic, or the surfaces of the paper press rollers 72 are coated with a water repellent material. Thereby, the function of protecting the recording surface at the time of cutting of, particularly, the rolled paper that has been subjected to frameless recording, can be improved further. As shown in FIG. 17, the ink absorbing material 216 required at the time of frameless recording is provided at only locations corresponding to both side edges of the paper. Hence, during frameless recording performed by the large-sized inkjet printer 100, printing is performed at both side edges of the paper. However, at the leading edge of the paper, printing is started after a margin of about 1 mm has been left from the edge. When the leading edge of the paper has reached the position of the cutting apparatus 70 during printing operation, the margin is cut by the cutter blade 71. A trailing edge of the paper is cut so as not to leave a margin when the rolled paper is cut for output. When frameless recording is performed, the paper press rollers 72 roll over a wet recording surface. Even in such a case, ink does not adhere to the paper press rollers 72, by virtue of the water repellent effect thereof, thus preventing occurrence of defects in a recorded image. Here, the invention can also be applied similarly to a case where the ink absorbing material 216 is disposed at positions corresponding to the leading and trailing edges of the paper as well as at the positions corresponding to the side edges of the paper, and the same advantage is also yielded.

The paper press rollers 72 are provided on both sides of the cutter blade 71 and press the rolled paper against the flat roller slide surface 76b byway of the rolled paper. Hence, even when, for example, the roller paper has become curled up, the portion of the rolled paper corresponding to the cutter blade 71 can be made flat at the time of cutting operation. Moreover, the cutter blade 71 can be moved straight without fail by means of the cutter groove step 76a. Hence, the high cutting accuracy of the rolled paper can be maintained at all times. Specifically, a cut surface of the rolled paper can be made stable, and superior cutting performance can be achieved.

Further, the cutter blade 71 and the paper press rollers 72 may be moved in the transverse direction in plural times for completing the cutting operation. In such the case, the high cutting accuracy as well as linearity of the cutting surface paper can be achieved. For example, the cutter blade may be moved on a single cutting line of the rolled paper in plural times so that the rolled paper is cut sequentially in thickness direction at the cutting line.

Also, there is adopted a system for sequentially cutting the rolled paper from both sides toward its center; for example, three-step cutting or four-step cutting. As a result, when the rolled paper is cut from one side in a single operation, a part of the rolled paper that is immediately before separated from the rest comes close to the center, because of the self weight of the rolled paper. This phenomenon sometimes results in inclination of the cut surface. The sequential cutting can prevent occurrence of such a phenomenon, thereby rendering the cut surface straight. Thus, the high cut accuracy of the rolled paper can be maintained at all times.

As shown in FIG. 18B, the plunger 75 brings the cutter blade 71 and the paper press rollers 72 into contact with or out of contact with the rolled paper by means of vertically actuating the holder 73. Thus, the cutter blade 71 and the paper press rollers 72 can be pressed against the rolled paper without fail at the time of cutting of the rolled paper, thereby enabling highly-accurate cutting operation. Further, when the cutting apparatus 70 is not in use, such as when the rolled paper is discharged, the cutter blade 71 and the paper press rollers 72 can be spaced from the rolled paper without fail and held in a retracted state. Hence, the cutter blade or the paper press rollers interfering with the rolled paper can be prevented.

Various embodiments of the invention have been described. However, the invention is not limited to the embodiments, Naturally, the invention can also be applied to other embodiments falling within the scope of the invention described in the appended claims. For example, in the embodiment, the invention has been described by taking the inkjet printer as the liquid fixing apparatus. However, the invention is not limited to the inkjet printer. The invention can also be applied to any liquid fixing apparatus or recording apparatus; for example, a dot impact recording apparatus, a facsimile apparatus or a copier, so long as the apparatus has a cutting apparatus.

What is claimed is:

1. A cutting apparatus for cutting a fixing-medium, comprising:
a press roller which rotationally moves while pressing the fixing-medium in a transverse direction of the fixing-medium; and
a cutter blade which moves in conjunction with the press roller and pressingly cuts the fixing-medium in the transverse direction of the fixing-medium.

2. A cutting apparatus according to claim 1, wherein the press roller is provided on either side of the cutter blade.

3. A cutting apparatus according to claim 1, wherein the press roller is formed from PFA resin.

4. A cutting apparatus according to claim 1, wherein a surface of the press roller which comes into contact with the fixing-medium is subjected to water repellent treatment.

5. A cutting apparatus according to claim 1, further comprising an actuating device for bringing the press roller and the cutter blade into contact with or out of contact with the fixing-medium.

6. A liquid fixing apparatus for liquid-fixing information on a fixing-medium comprising:
a press roller which rotationally moves while pressing the fixing-medium in a transverse direction of the fixing-medium; and
a cutter blade which moves in conjunction with the press roller and pressingly cuts the fixing-medium in the transverse direction of the fixing-medium.

7. A liquid fixing apparatus according to claim 6, wherein the press roller is provided on either side of the cutter blade.

8. A liquid fixing apparatus according to claim 6, wherein the press roller is formed from PFA resin.

9. A liquid fixing apparatus according to claim 6, wherein a surface of the press roller which comes into contact with the fixing-medium is subjected to water repellent treatment.

10. A liquid fixing apparatus according to claim 6, wherein the cutting apparatus further includes an actuating device for bringing the press roller and the cutter blade into contact with or out of contact with the fixing-medium.

11. A liquid fixing apparatus according to claim 6, wherein the cutting apparatus is fixed to a carriage on which a recording head is mounted.
